(19) United States
(12) Patent Application Publication
(10) Pub. No.: US 2022/0326208 A1
(43) Pub. Date: Oct. 13, 2022

(54) MONITORING OF FOOD PRODUCT TEST RECORDS BASED ON BATCH ID

(71) Applicant: Tetra Laval Holdings & Finance S.A., Pully (CH)

(72) Inventors: Kacy Brown, Flower Mound, TX (US); Domenico Barbatano, Marane!lo (IT); Karin Marcovecchio, Dalby (SE)

(21) Appl. No.: 17/225,144

(22) Filed: Apr. 8, 2021

(51) Int. Cl. G01N 33/02; G06F 16/906; G06F 16/9035

(52) U.S. Cl. CPC G01N 33/02; G06F 16/906; G06F 16/9035

(57) ABSTRACT

Methods and apparatus, including computer program products, for food product testing in a production system. An automatic determination is made in response to entering a product sampling value for a food product into an electronic test record, wherein the food product is associated with a batch identifier, as to whether the product sampling value fits within a specified range of product sampling values. The food product is classified based on the determination into a completed, pending, or quarantine class. Information about the classification of the food product is provided to a user and the user is prompted to take an action with respect to the food product. The provided information and the prompted action are customized based on a role of the user.

### BACKGROUND

The present invention relates to testing of food products in a production system. In food production today, there are strict food safety regulations to be followed to make sure that consumers are not harmed by food products. The food safety regulations stipulate, for example, which kind of materials that are allowed to be in contact with food products, how often samples should be taken, what type of tests that should be performed on the samples, at which temperature and for how long time the food product should be heat treated in order to be considered safe to consume, and so on. Further, the food products may also be tested for other purposes, such as color, flavor, etc., which may be important, but which may not have any relation to the safety of the food product.

While the testing typically is automated to a high degree, there is also significant testing that is carried out manually by lab technicians and other production plant personnel. Often, the results of such manual testing are recorded on paper by the lab technicians, transferred manually into electronic test records for a food product, and finally reviewed by a quality manager (or through some partly or wholly automated process) who decides whether the food product may advance to the next step in the production system, or whether further testing of the food product is necessary.

This manual portion of the testing may be prone to a number of potential problems. For example, unintentional errors may occur during the transfer of measurement results from paper to a digital format, which might result in either false negative or false positive values. It may also be difficult for a quality manager to review a large number of records for a several products and quickly discover potential problems and decide on what next measures to take, and to efficiently communicate these measures to the lab technicians in the production facility. As a result, it may be necessary to slow down or even stop the food production system for significant periods of time while these issues are being resolved, and at worst, food safety may even be jeopardized if insufficient testing was done. For at least these reasons, there is a need for improved food product quality control tools.

### SUMMARY

It is an object of the invention to at least partly overcome one or more of the above-identified limitations of the prior art. In particular, it is an object to provide methods and systems for product testing in a production system that provides a higher degree of automation and customization and allows various categories of users to view information that is particularly pertinent to them, thereby enabling more rapid and accurate responses to any food quality related issues that may arise in the production system.

According to a first aspect, the invention relates to a method for food product testing in a production system. The method includes:
in response to entering a product sampling value for a food product into an electronic test record, wherein the food product is associated with a batch identifier, automatically determining whether the product sampling value fits within a specified range of product sampling values;
based on the determination, classifying the food product into one of the following classes: completed, pending, and quarantine; and
providing information about the classification of the food product to a user and prompting the user to take an action with respect to the food product, wherein the provided information and the prompted action is customized based on a role of the user.

On a general level, this invention provides for more efficient and accurate assessment of food product quality, or other aspects of a food product, in a production system. In particular, the invention allows testing and monitoring of food products on a batch level. As is well known to those having ordinary skill in the art, a food product is typically associated with a batch identifier that includes a certain combination of numbers and/or letters, which identifies and enables tracing a set of food products sharing certain characteristics of production (e.g., production time, production date, identification code, etc.). The batch identifier ensures product traceability and data on the history and background of the food product. Being able to link test results to a particular batch identifier makes it possible to quickly identify other food products that share the same characteristics and, therefore likely would need to be handled in a similar way to the tested food product.

When a product sampling value is entered into the electronic test record, which can be done with varying degrees of automation depending on the particular testing equipment that is being used, it is automatically determined whether the product sampling value fits within a specified range of product values. The specified range has typically been defined beforehand by a quality manager or some other individual who is authorized to define a range of allowable values for a particular test of a particular food product. By automatically comparing the entered product sampling value with the range of acceptable product sampling values, it is possible to instantaneously determine whether a product sampling value for the food product is acceptable or needs further attention. Making such a determination automatically both increases the speed and the accuracy of the determination, and ultimately also reduces the risk of food safety issues, as more rapid action can be taken in response to detecting any irregularities.

Based on the determination, the sampled food product is classified into a completed, pending, or quarantine class. These classes can be associated with different actions that need to be taken with respect to the food product for the particular class. For example, one set of actions should be taken for all the food products belonging to the “completed” class, whereas another action should be taken for food products in the “quarantine” class, and so on. Having the ability to classify food products into different classes makes it easy for a quality manager to get a quick overview of the status of the production system as a whole, compared to having to examine individual test records. This is particularly useful when multiple food products are being produced concurrently in a production plant.

The information can be provided on a graphical user interface (GUI) on a client computer, and quick glance at the different classes can give the product manager an instantaneous idea about what needs to be done next in the production system. The GUI can also contain prompts asking the production manager (or other individual) reviewing the information for what next steps to take, as will be further described above. These can be open-ended prompts or be pre-defined suggestions of possible actions, as will be described in further detail below. Typically, the information that is shown on the GUI is customized based on the role of the user. For example, a lab technician may view different information from a product manager, etc., as she may be more interested in what re-sampling needs to be done, rather than the overall status of the production plant, for example. This further provides a better and quicker overview for particular individuals having particular roles, as the information that is displayed is particularly relevant to the role of the person viewing the information. As a consequence, swifter action can be taken, compared to when the same information is shown irrespective of the user's role and the user would need to find their way to the relevant information. This allows potential problems with a particular batch to be addressed more rapidly.

According to one embodiment, the sampling value is obtained and entered automatically into the electronic test record by a piece of equipment in the production system. This enables quicker and more accurate data entry, compared to when data is entered manually by a person, and as a result corrective actions can also be taken more rapidly.

According to one embodiment, each batch has a plurality of associated electronic test records corresponding to different sampling values. For example, a given batch may have one set of electronic test records relating to pH value and another set of electronic test records relating to temperature.

According to one embodiment, the batch identifier is associated with a start date for processing the food product in the production system, and is linked to other sections of a production plant, including one or more of: a warehouse section, a product preparation section, a claims section and a packaging section. Testing the food product on a batch identifier basis enables traceability of the product, that is. Knowing where the product has been prior to testing can help figure out the source of the potential problem, especially if it is discovered later on that there are other batches that suffer from the same problem.

According to one embodiment, the completed classification indicates that the electronic test record is complete with respect to the sampled feature and no further action is necessary with respect to testing that feature of the food product; the pending classification indicates that the electronic test record is incomplete with respect to the sampled feature and that further action is necessary with respect to testing that feature of the food product; and the quarantine classification indicates that one or more sample values may be out of range and further actions are necessary to evaluate the quality testing of the food product. This straightforward way of classifying food products makes it possible for a quality manager to immediately identify which food products in the production plant are ready to proceed to the next step, what products may have problems and may need further testing by lab technicians, or which food products are currently undergoing testing. This greatly facilitates the decision process for the quality manager, as well as the workflow in the production plant, and the accuracy and safety of production since no batch of food products is allowed to proceed until the testing has been completed.

According to one embodiment, the information about the classification of the food product and the prompt to the user to take an action are displayed as a customized view on a landing page of a client user interface and wherein the role of the user is determined from login credentials for the user. Each user in a production plant has a particular role, and particular tasks they need to perform. For example, a production plant manager performs a different set of tasks compared to a lab technician. By coupling these roles to users' login credentials, it is possible to display a view that is customized to the particular role of a user when the user logs into the system. For example, a production plant manager may see an overview of the status of the different food products and batches in the plant, whereas a lab technician may see what particular tests need to be done next on particular batches. Again, this facilitates the workflow and the accuracy of the operations of the production plant, which ultimately has an impact on the safety and quality of the food product.

According to one embodiment, the prompted action for a quarantine classification includes one or more of: reviewing the electronic test record and resampling certain features of the food product, and reviewing and approving or rejecting the electronic test record. Depending on the user role, different prompts may be provided. For example, when a food product has a quarantine classification, a user (typically a quality manager or a production plant manager) may be prompted to review the electronic test record and discover that further resampling of the food product is necessary, or she may be prompted to review the electronic test record and approving it to allow the food product to advance to the next step in the production process.

According to one embodiment, the method further comprises: automatically transmitting a control signal to one or more pieces of equipment in the production system to execute the action by the one or more pieces of equipment. Some of the food processing or testing equipment can be integrated with the quality management system, so that test results can be reported automatically, or re-testing can be done automatically without the involvement of a lab technician, or the product can even be advanced automatically without the explicit approval of a production manager when all the electronic test records are in the complete classification. This higher level of automation and reduction in manual intervention enables further efficiencies and accuracies to be accomplished in the production plant, again ultimately contributing to the quality and safety of the food product.

According to one embodiment, the method further comprises: receiving information from a user defining a set of customized views and associated prompted actions. Every food production plant is slightly different from other ones, depending on the type of food product that is being produced in the plant, the size of the plant, the user roles of the production plant staff, etc. Therefore, the user interface is customizable such that the different views, and the prompted actions, can be adapted to the particular production plant in which the system is used. This ensures that only the most relevant information is displayed to the respective users at any given time, which enables better decision making and efficiency of the production plant management.

According to one embodiment, the method further comprises: tracking any actions taken by the user in response to the prompt; and generating a customized report based on one or more of: the classification of the food product and the actions taken by the user. For audit reasons, it is important to have a track record of the measures that were taken with respect to a particular batch of food product at a particular time. Therefore, a reporting functionality is also included which allows the creation of customized reports with respect to a particular batch and what events the batch has undergone during its time in the production plant, and which users performed such events. This further enhances the traceability and makes any ex post facto investigations easier, should there be a need to figure out what went wrong with a particular batch or figure out why several batches suffer from the same issues.

According to one embodiment, the method further comprises: reviewing all electronic test records associated with the batch identifier; and in response to determining that all electronic test records have a completed classification, clearing the food product to progress in the production system. Typically, as a further safety measure, a food product is not allowed to progress in the production system until all electronic test records have been classified as “completed.” This eliminates the chances of a food product being advanced inadvertently if a user somehow were to miss a step in the test record approval process.

According to a second aspect, the invention relates to a system for food product testing in a production environment. The system includes a memory and a processor. The memory contains instructions that when executed by the processor causes the processor to perform a method that includes:
in response to entering a product sampling value for a food product into an electronic test record, wherein the food product is associated with a batch identifier, automatically determining whether the product sampling value fits within a specified range of product sampling values;
based on the determination, classifying the food product into one of the following classes: completed, pending, and quarantine; and
providing information about the classification of the food product to a user and prompting the user to take an action with respect to the food product, wherein the provided information and the prompted action is customized based on a role of the user.

The system advantages correspond to those of the method and may be varied similarly.

According to a third aspect, the invention relates to a computer program product for food product testing in a production environment. The computer program comprises a computer readable storage medium with instructions to carry out the following steps when executed by a processor:
in response to entering a product sampling value for a food product into an electronic test record, wherein the food product is associated with a batch identifier, automatically determining whether the product sampling value fits within a specified range of product sampling values;
based on the determination, classifying the food product into one of the following classes: completed, pending, and quarantine; and
providing information about the classification of the food product to a user and prompting the user to take an action with respect to the food product, wherein the provided information and the prompted action is customized based on a role of the user.

The computer program involves advantages corresponding to those of the method and may be varied similarly.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 shows a schematic block diagram of a quality data management system, in accordance with one embodiment.

FIG. 2 shows a flowchart of a process for food product quality data management, in accordance with one embodiment.

Like reference symbols in the various drawings indicate like elements.

### DETAILED DESCRIPTION

As was described above, a goal with the various embodiments of the invention is to provide methods and systems for product testing in a production system that provides a higher degree of automation and customization and allows various categories of users to view information that is particularly pertinent to them, thereby enabling more rapid and accurate responses to any food quality related issues, or other aspects relating to the food product, that may occur in the production system. This is achieved by a system that allows for monitoring food products on a batch level, and integrates the results of the testing into customizable views for various user roles within the production environment. The system components and their interactions will now be described in further detail by way of example and with reference to the drawings.

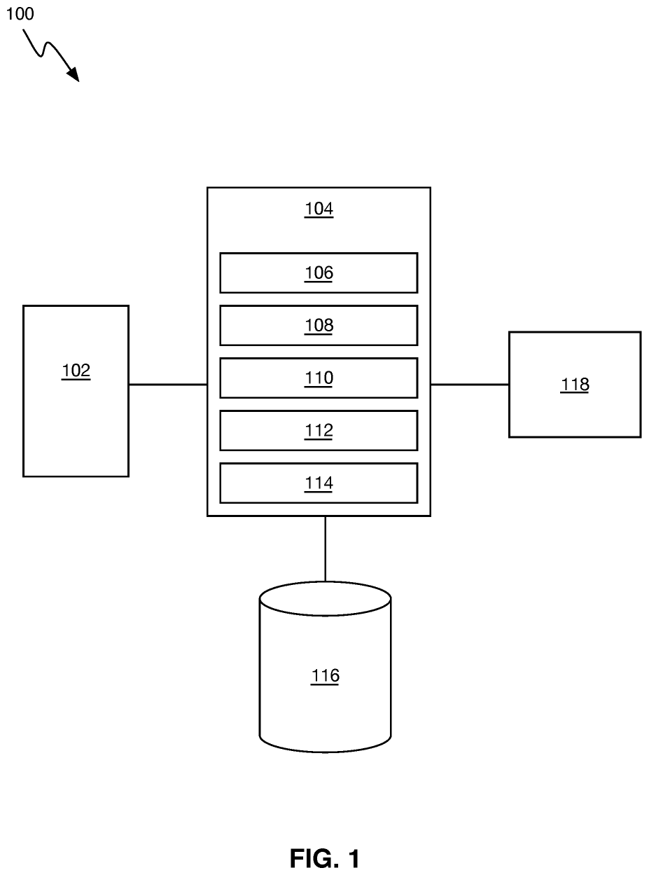

FIG. 1 shows a Quality Data Management System (QDMS) 100 in accordance with one embodiment. As can be seen in FIG. 1, QDMS 100 includes production and testing equipment 102, a QDMS engine 104, and a client 118. It should be noted that depending on the particular embodiment at hand, the production and testing equipment 102 can be integrated in the system 100, but can alternatively be a completely separate system that is merely in communication with the QDMS engine 104, or certain parts of the production and testing equipment 102 can be part of the system 100, whereas others are not. Thus, many possible embodiments can exist, based on the particular circumstances at hand.

The production and testing equipment 102 represents the environment that is installed and configured on the production plant and includes the physical machines (production lines) and all the software needed for the management of the production equipment. Among those of particular interest to quality data management are the applications that provide the QDMS engine 104 with the information relating to the composition of the production line and the event logs (sampling occasions) that occurred on a given machine and at any given time.

The production and testing equipment 102 is in communication with the QDMS engine 104. In the embodiment shown in FIG. 1, the QDMS engine 104 is implemented as a set of microservices that perform the core operations of the whole QDMS 100, from taking the data as it arrives from the production and testing equipment 102 and saving it in a QDMS database 116, to the management of all the functionality of the client web application 118.

Each microservice is implemented to carry out certain functionalities. For example, in the implementation shown in FIG. 1, there is a configuration tool component 106 for configuring the particular testing that is needed and what is considered allowable sample value ranges, etc., a quality test component 108 for insertion of the test results of the quality tests and the validation pages (Batch status page), a reporting component 110 for creating reports concerning the quality testing, a web application component 112 for configuring the user interface of the web application 118 to determine what users will see based on their respective roles, and a system log component 114 that logs system events to track the status of the production and QDMS 100 at any given point in time. It should be noted that this is merely one possible microservices configuration, and that there may be additional or fewer microservices in the QDMS engine 104 based on the particular setup at the production plant.

The concept of microservices is well known to those having ordinary skill in the art and will therefore not be discussed in any detail herein. On a general level, though, the microservice architectural style can be described an approach to developing a single application as a suite of small services, each running in its own process and communicating with lightweight mechanisms, often a hypertext transfer protocol (HTTP) resource application programming interface (API). These services are built around specific tasks and are independently deployable by fully automated deployment machinery. There is a bare minimum of centralized management of these services, which may be written in different programming languages and use different data storage technologies. As a result, whenever there is a change to a certain functionality of the system, only the particular microservice that is involved with that functionality needs to be changed, rather than the entire server side application which has traditionally been the case in so-called monolithic applications that are built as a single unit on a server.

In one implementation, the QDMS database 116 contains all the values collected by the production and testing equipment 102 as electronic test records, as well as lists of tests to be performed on the collected packages, defects to be associated during the tests, the history of production batches, the history of the quality tests conducted. The QDMS database 116 can be implemented using standard techniques, for example, as a relational database.

The client 118 can be any type of computing device that is capable of running a web browser, which functions as a user interface to the web application component 112 on the QDMS engine 104. However, it should be noted that in certain implementations, the same functionality can be implemented in proprietary software that does not use a web-based user interface, and or by the use of special purpose computers. The client 118 authenticates the user, for example, through username and password or some other conventional or proprietary authentication mechanism, before communicating with the web application component 112 using the web browser on the client 118. As was mentioned above, each user has an associated role that allows the user to view and use only the appropriate sections of the software, based on the permissions associated with the role.

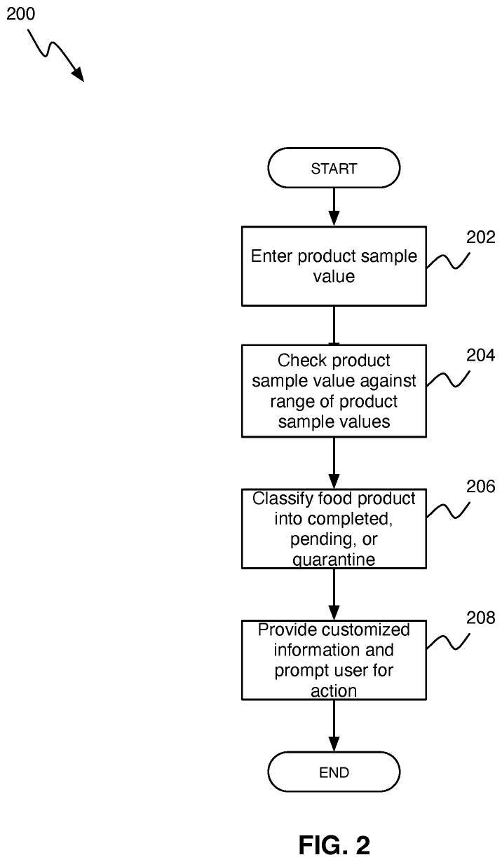

Lastly, it should be noted that while only a single client 118 is illustrated in FIG. 1, in a typical implementation there will be multiple clients 118, which may be stationary or portable and be connected to the QDMS engine 104 through a wired or wireless connection. Similarly, there may be several QDMS databases 116, which contain different types of data associated with the sampling of the food products within the production environment. Thus, the specific embodiment shown in FIG. 1 is merely on example embodiment and should not be considered as limiting the scope of what is recited in the claims. The functionality of QDMS 100 and the interaction of its components will now be described in greater detail with respect to FIG. 2.

FIG. 2 shows a method 200 for product quality data management, which can be implemented in the QDMS 100 of FIG. 1, in accordance with one embodiment. As can be seen in FIG. 2, the method 200 starts by entering a product sample value for a food product into an electronic test record, step 202. As was described above, the entry of the product sample value can be done either manually or automatically, depending on the level of integration of the production and testing equipment 102 with the QDMS 100.

Next, the product sampling value is checked against a specified range of product sampling values, step 204. Typically, the specified range of product sampling values is a range of approved values for the particular test that is carried out on the food product (e.g., a certain pH value), and has been established beforehand, typically at system setup, by authorized food safety personnel.

Based on the result of the check in step 204, the food product, or more specifically the particular batch of the food product, is classified into a completed, pending, or quarantine class, step 206. The completed classification indicates that the electronic test record is complete and that no further action is necessary with respect to quality testing of the particular batch of the food product. Typically, this classification is given when all product sample values fall within the allowable range of product sample values for all tested aspects of the food product. The pending classification indicates that the electronic test record is incomplete and that further action is necessary with respect to quality testing of the food product. Lastly, the quarantine classification indicates that one or more sample values may be out of range and further actions are necessary to evaluate the quality testing of the food product, or even discard the particular batch of the food product.

Once the food product has been assigned a class, customized information is provided to the user, and the user is prompted to take an action, step 208, which ends the process 200. As was described above, the information may be customized such that a product quality technician and a product manager, respectively, views different information when they log in on their respective clients 118. Typically, this particular information is based on the user role associated with the individual's login credentials.

For example, upon login a quality manager may see a “Quarantine” section and a “Pending” section on the login screen. The Quarantine sections contains all test and their statuses for food products in quarantine. The status indicates “where” the test record is at the moment. The “Pending” section contains only the particular test where one or more deviations has been reported.

A lab technician on the other hand may see the same Quarantine and Pending sections. However, the content in these sections may be different for the lab technician. The Quarantine section may display only the test records that are “waiting for test” and “Test ongoing,” since it is the lab technician's job to perform the tests. The Pending section for the lab technician may display all test records having a pending status, as it is the lab tech who completes the tests.

Further, a warehouse operator may see a different type of landing page, which contains an “Open defects” section and a “Resample” section. The Open Defects section can contain those defects that are still being investigated, for example, and the Resample section can contain requests from the lab to retrieve a certain number of packages to perform resampling. The exact layout of the various landing pages for these different roles, and the specific information that is contained on each page can vary between different embodiments. Typically, these decisions are made as part of a configuration process when the QDMS 100 is initially set up for a particular food production situation, and these decisions and configuration options lie well within the skills of a person having ordinary skill in the art and will therefore not be discussed here in any further detail. Suffice it to say that the exact appearance of the graphical user interface is not central to the invention, but rather the notion of being able to customize the appearance such that the most relevant information is included for each role a user of QDMS 100 may have.

It should be noted that this process 200 can be repeated as many times as needed, for example, as a result of a product quality manager requesting resampling of the food product, until the food product eventually is classified as completed and is ready to proceed to the next step in the production. As was mentioned above, each product generally has a number of different associated electronic test records, which correspond to different product sampling types. For example, there may be one test record for pH values, another one for temperature, another one for sugar level, etc. Typically, the food product is not allowed to proceed in the production process until all electronic test records fall within the completed classification.

Again, it should be noted that the process 200 may also result in automated actions being taken by the production and testing equipment 102. For example, if a temperature registers as being too low or too high for a food product, the production and testing equipment 102 can automatically regulate the temperature to an appropriate setting. In situations where product sampling is done automatically, the production and texting equipment 102 can perform resampling after certain parameters have been adjusted, without any intervention of a lab technician. Exactly what parameters can be controlled and the mechanisms for controlling them may vary widely depending on the particular implementation at hand, and such adjustments fall well within the knowledge of a person having ordinary skill in the art.

Some embodiments also contain reporting functionality, which can be provided, for example by the reporting component 110, typically in conjunction with the system log component 114. This makes it possible to provide various types of reports or statistical data. For example, assume there is a filling machine for a particular food product. The system log component can obtain data from the production and testing equipment 102 (of which the filling machine is a part) and that data can be combined with the quality data for the food product into a report that links the filling machine performance and quality data together, and can provide valuable information about any future adjustments and/or other actions that may be needed.

It should be noted that there are many variations to the above examples which fall within the scope of the appended claims. Thus, many variations can be envisioned by those having ordinary skill in the art. The systems and methods disclosed herein can be implemented as software, firmware, hardware or a combination thereof. In a hardware implementation, the division of tasks between functional units or components referred to in the above description does not necessarily correspond to the division into physical units; on the contrary, one physical component can perform multiple functionalities, and one task may be carried out by several physical components in collaboration.

Certain components or all components may be implemented as software executed by a digital signal processor or microprocessor, or be implemented as hardware or as an application-specific integrated circuit. Such software may be distributed on computer readable media, which may comprise computer storage media (or non-transitory media) and communication media (or transitory media). As is well known to a person skilled in the art, the term computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that a person skilled in the art can modify the above-described embodiments in many ways and still use the advantages of the invention as shown in the embodiments above. Thus, the invention should not be limited to the shown embodiments but should only be defined by the appended claims. Additionally, as the skilled person understands, the shown embodiments may be combined.

What is claimed is:

1. A method for food product testing in a production system, comprising:
in response to entering a product sampling value for a food product into an electronic test record, wherein the food product is associated with a batch identifier, automatically determining whether the product sampling value fits within a specified range of product sampling values;
based on the determination, classifying the food product into one of the following classes: completed, pending, and quarantine; and
providing information about the classification of the food product to a user and prompting the user to take an action with respect to the food product, wherein the provided information and the prompted action are customized based on a role of the user.

2. The method of claim 1, wherein the sampling value is obtained and entered automatically into the electronic test record by a piece of equipment in the production system.

3. The method of claim 1, wherein each batch has a plurality of associated electronic test records corresponding to different sampling values.

4. The method of claim 1, wherein the batch identifier is associated with a start date for processing the food product in the production system, and is linked to other sections of a production plant, including one or more of: a warehouse section, a product preparation section, a claims section, and a packaging section.

5. The method of claim 1, wherein:
the completed classification indicates that the electronic test record is complete with respect to the sampled feature and no further action is necessary with respect to testing that feature of the food product;
the pending classification indicates that the electronic test record is incomplete with respect to the sampled feature and that further action is necessary with respect to testing that feature of the food product; and
the quarantine classification indicates that one or more sample values of the sampled feature may be out of range and further actions are necessary to evaluate the testing of that feature of the food product.

6. The method of claim 1, wherein the information about the classification of the food product and the prompt to the user to take an action are displayed as a customized view on a landing page of a client user interface and wherein the role of the user is determined from login credentials for the user.

7. The method of claim 1, wherein the prompted action for a quarantine classification includes one or more of: reviewing the electronic test record and resampling the food product, and reviewing and marking the electronic test record as completed.

8. The method of claim 1, further comprising:
automatically transmitting a control signal to one or more pieces of equipment in the production system to execute the action by the one or more pieces of equipment.

9. The method of claim 1, further comprising:
receiving information from a user defining a set of customized views and associated prompted actions.

10. The method of claim 1, further comprising:
tracking any actions taken by the user in response to the prompt; and
generating a customized report based on one or more of: the classification of the food product and the actions taken by the user.

11. The method of claim 1, further comprising:
reviewing all electronic test records associated with the batch identifier; and
in response to determining that all electronic test records have a completed classification, clearing the food product to progress in the production system.

12. A system for food product testing in a production environment, comprising:
a memory; and
a processor,
wherein the memory contains instructions that when executed by the processor causes the processor to perform a method that includes:
in response to entering a product sampling value for a food product into an electronic test record, wherein the food product is associated with a batch identifier, automatically determining whether the product sampling value fits within a specified range of product sampling values;
based on the determination, classifying the food product into one of the following classes: completed, pending, and quarantine; and
providing information about the classification of the food product to a user and prompting the user to take an action with respect to the food product, wherein the provided information and the prompted action are customized based on a role of the user.

13. A computer program product for food product testing in a production environment, the computer program product comprising a computer readable storage medium having program instructions embodied therewith, wherein the computer readable storage medium is not a transitory signal per se, the program instructions being executable by a processor to cause the processor to perform a method comprising:
in response to entering a product sampling value for a food product into an electronic test record, wherein the food product is associated with a batch identifier, automatically determining whether the product sampling value fits within a specified range of product sampling values;
based on the determination, classifying the food product into one of the following classes: completed, pending, and quarantine; and
providing information about the classification of the food product to a user and prompting the user to take an action with respect to the food product, wherein the provided information and the prompted action are customized based on a role of the user.
